(19) United States
(12) Patent Application Publication
(10) Pub. No.: US 2026/0061570 A1
(43) Pub. Date: Mar. 5, 2026

(54) GRIPPING TOOL

(71) Applicants: TING-WEI CHU, Taichung City (TW); TSE-MING LIN, Taichung City (TW)

(72) Inventors: TING-WEI CHU, Taichung City (TW); TSE-MING LIN, Taichung City (TW)

(21) Appl. No.: 18/819,338

(22) Filed: Aug. 29, 2024

(51) Int. Cl. B25B 13/44

(52) U.S. Cl. CPC B25B 13/44

(57) ABSTRACT

A gripping tool includes a sleeve ring, a clamping assembly, and a driving member. The sleeve ring defines an axis, and has a receiving groove and a combination portion on two ends relative to the axis. The receiving groove has a guiding portion. The clamping assembly is disposed in the receiving groove, and includes multiple clamping blocks and elastic members. Each clamping block is arranged around the axis. Two ends of each elastic member abut two neighboring clamping blocks. The driving member has opposite first and second ends, the first end rotationally disposed in the sleeve ring along the axis and abutting the clamping assembly, the second end having a concave stepped connection bore. When the driving member rotates relative to the axis, the clamping assembly slides obliquely along the guiding portion, and the clamping blocks move away from or toward the axis, gripping objects of different sizes for removal.

### BACKGROUND OF THE INVENTION

### 1. Field of the Invention

The present invention relates to hand tools for removal, and more particularly, to a gripping tool used to grip objects with different sizes for removal.

### 2. Description of the Related Art:

A conventional socket has one end used to be connected with a socket wrench, while the other end of the conventional socket has a gripping part capable of being mounted around bolts, nuts, or other threaded components. When the user rotates the socket wrench, the socket drives the threaded component to rotate, thereby tightening or loosening it.

However, the conventional socket has a fixed inner diameter of the gripping part, so as to be only applicable to threaded components having specifically matching inner diameters. Because different threaded components have different sizes, the user has to prepare multiple single-sized sockets with different inner diameters to fulfill different operation demands.

Therefore, the user suffers from inconvenience and burden of the necessity of carrying multiple sockets. Also, lack or damage of sockets of specific sizes would lead to interruptions in the operation of rotating threaded components, causing significant disruptions of operation.

### SUMMARY OF THE INVENTION

To improve the issues above, the present invention discloses a gripping tool. By use of the driving member to control the axial movement of the clamping assembly, the opening and closing of the clamping assembly is adjusted to clamp objects with different sizes, thereby enhancing the application scope of the tool

For achieving the aforementioned objectives, the present invention provides a gripping tool, comprising:
a sleeve ring defining an axis passing through a center thereof, with a receiving groove and a combination portion disposed on two ends of the sleeve ring with respect to the axis, the receiving groove in communication with the combination portion, the receiving groove comprising a guiding portion;
a clamping assembly disposed in the receiving groove of the sleeve ring, the clamping assembly comprising a plurality of clamping blocks and a plurality of elastic members, the clamping blocks arranged around the axis, each of the elastic members having two ends thereof abutting against two of the neighboring clamping blocks; and
a driving member comprising a first end and an opposite second end, the first end rotatably disposed in the sleeve ring along the axis and abutting against the clamping assembly, the second end comprising a concave and stepped connection bore; the connection bore divided into a first connection bore and a second connection bore; wherein when the driving member rotates with respect to the axis, the clamping assembly slides obliquely along the guiding portion, so that the clamping blocks move away from or toward the axis.

By use of the driving member to control the axial movement of the clamping assembly, the present invention adjusts the opening and closing of the clamping assembly to clamp objects with different sizes, so as to enhance the application scope of the tool. Accordingly, the present invention improves the inconvenience of the necessity of preparing different conventional sockets of various sizes.

Also, the present invention easily controls the movement of the clamping assembly through the rotation of the driving member, so as to be efficiently adjusted to the needed specifications for clamping objects with different sizes, thereby increasing the operation efficiency.

In addition, the guiding portion of the receiving groove enables each clamping block to slide along a specific track, such that the clamping process is accurately carried out, thereby effectively controlling the clamping force and the clamping position.

Further, through the elastic members of the clamping assembly, the present invention ensures the stable connection between the clamping blocks, so that the clamping force is stably provided during the clamping process, preventing accidental slipping.

### BRIEF DESCRIPTION OF THE DRAWINGS

FIG. 1 is a perspective view of the gripping tool in accordance with an embodiment of the present invention, illustrating the clamping assembly retracted into the sleeve ring.

FIG. 2 is an exploded view of the gripping tool in accordance with an embodiment of the present invention.

FIG. 3 is a cross-sectional view taken along line A-A in FIG. 1, illustrating the clamping assembly retracted into the sleeve ring.

FIG. 4 is a cross-sectional view taken along line B-B in FIG. 1, illustrating the clamping assembly retracted into the sleeve ring.

FIG. 5 is another perspective view of the gripping tool in accordance with an embodiment of the present invention, illustrating the clamping assembly protruding and exposed from the sleeve ring.

FIG. 6 is a cross-sectional view taken along line C-C in FIG. 5, illustrating the clamping assembly protruding and exposed from the sleeve ring.

FIG. 7 is a cross-sectional view taken along line D-D in FIG. 5, illustrating the clamping assembly protruding and exposed from the sleeve ring.

FIG. 8 is a sectional view of the gripping tool in accordance with another embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion. Embodiments of the present invention are illustrated in detail along with the drawings. However, the technical features included by the present invention are not limited to certain embodiments hereby provided. Scope of the present invention shall be referred to the claims, which include all the possible replacements, modifications, and equivalent features.

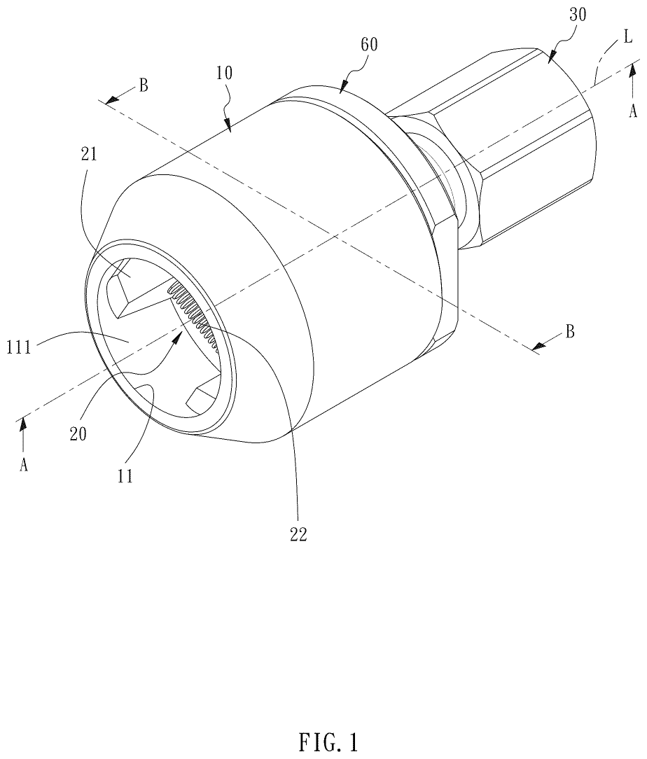

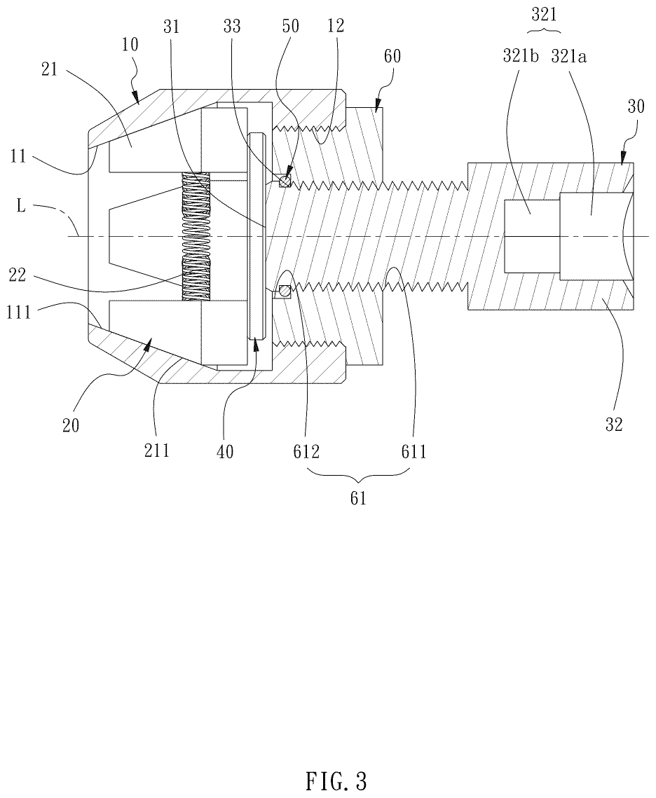

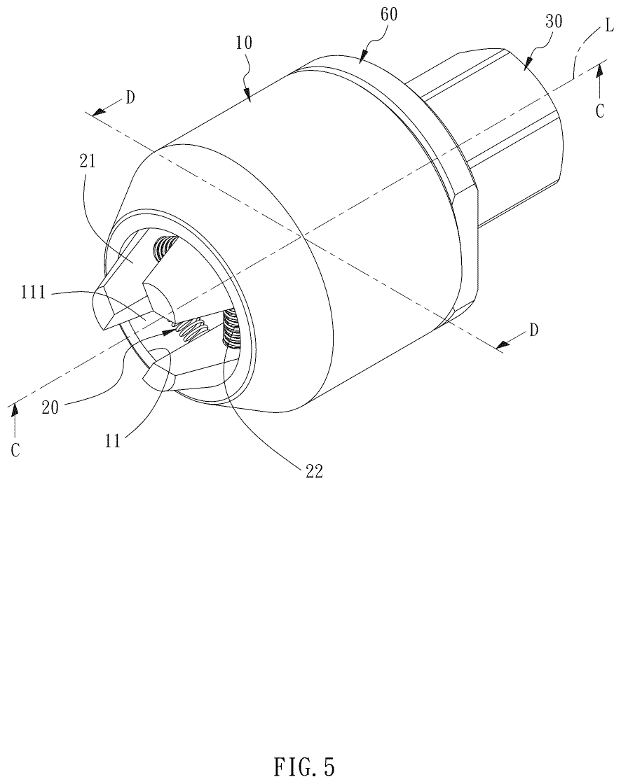

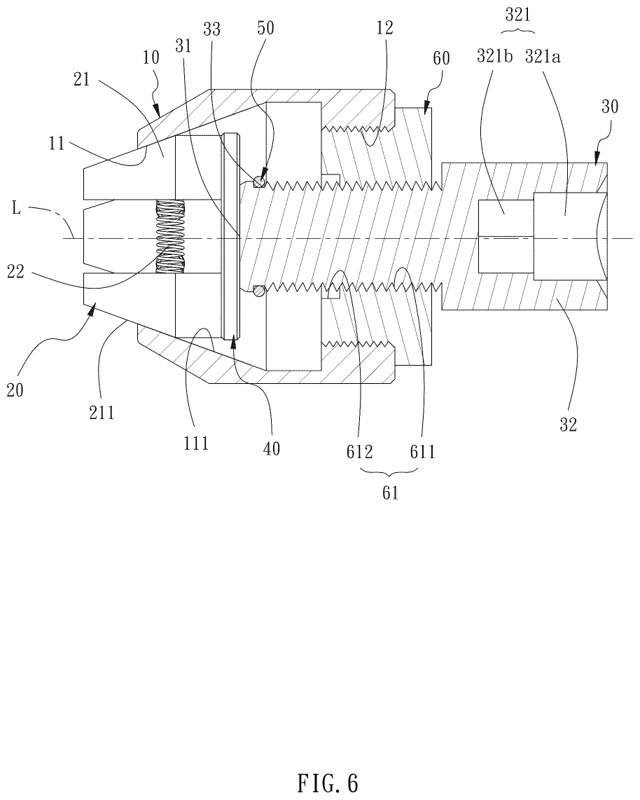

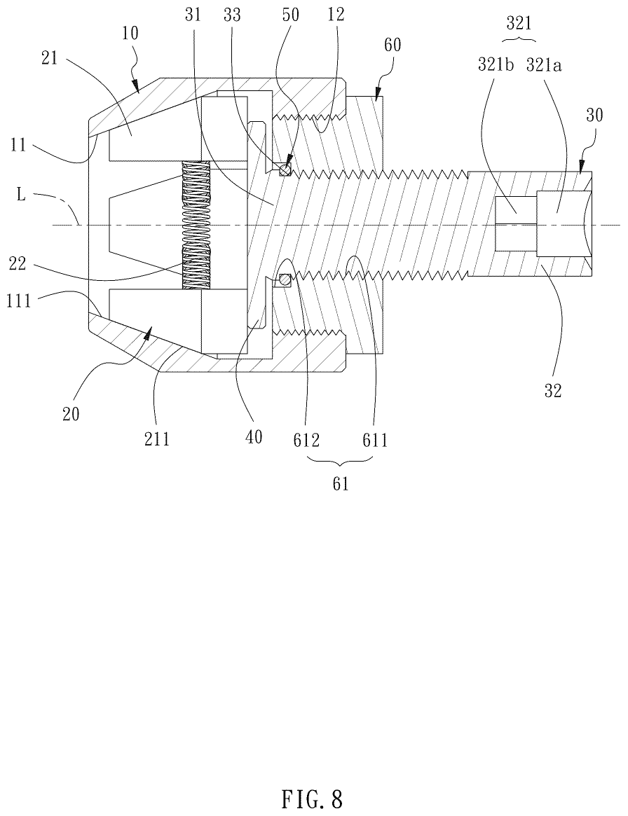

Referring to FIG. 1 to FIG. 8, the present invention provides a gripping tool, comprising a sleeve ring 10, a clamping assembly 20, and a driving member 30. The sleeve ring 10 is formed in an approximate circular column shape, with an axis L passing through the center thereof, as shown by FIG. 1 and FIG. 5. The sleeve ring 10 comprises a receiving groove 11 and a combination portion 12 disposed on two ends thereof with respect to the axis L. The receiving groove 11 is in communication with the combination portion 12. Therein, the receiving groove 11 comprises a guiding portion 111. In the embodiment, the guiding portion 111 is formed in a cone shape, and the inner wall thereof is formed in an arc face. The combination portion 12 is an open bore and provided with a thread, as shown by FIG. 3, FIG. 6, and FIG. 8.

The clamping assembly 20 is disposed in the receiving groove 11 of the sleeve ring 10. The clamping assembly 20 comprising a plurality of clamping blocks 21 and a plurality of elastic members 22. The clamping blocks 21 are arranged around the axis L. Each of the elastic members 22 has two ends thereof abutting against two of the neighboring clamping blocks 21. Therein, each clamping block 21 comprises a tilting contact face 211 and two connection faces 212, wherein the contact face 211 is connected between the two connection faces 212, and the contact face 211 of each clamping block 21 is attached to the guiding portion 111.

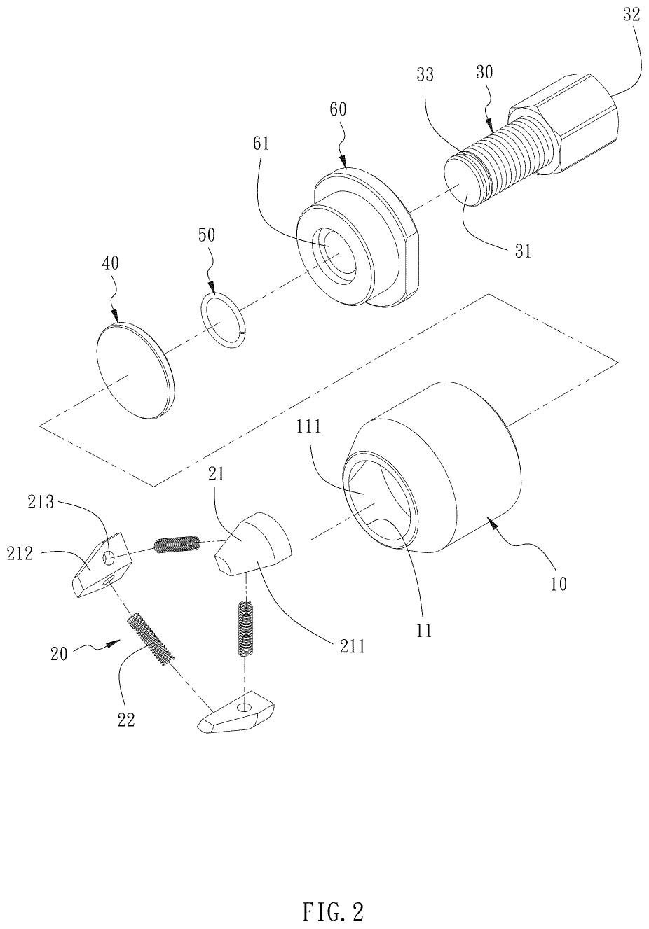

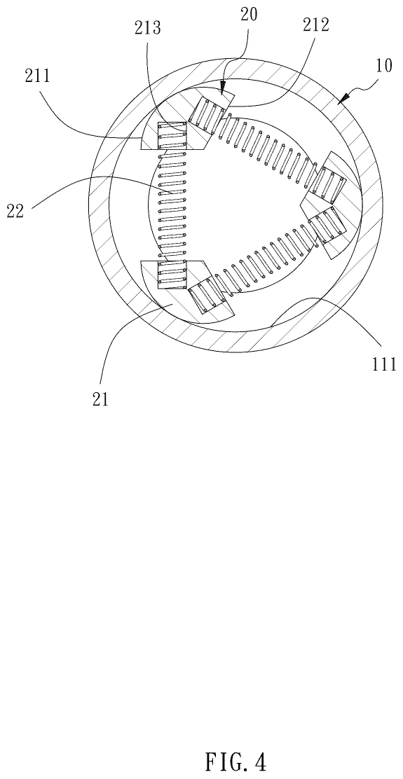

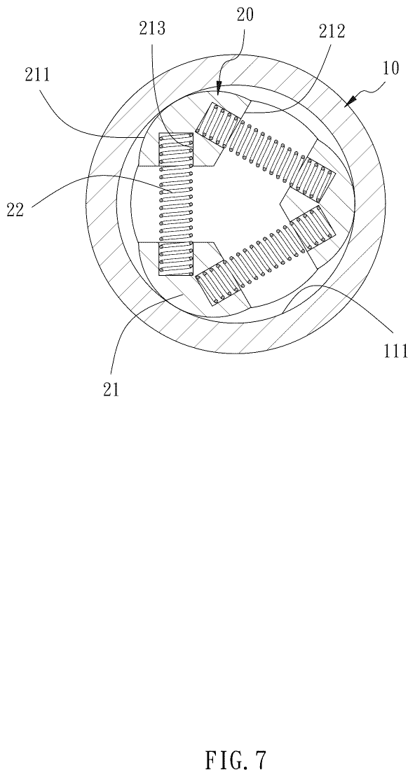

Also, the two connection faces 212 comprises a concave recess 213, respectively, and each elastic member 22 has two ends thereof abutting against the recess 213, respectively, as shown by FIG. 2, FIG. 4, and FIG. 7. Therein, the surface of the clamping block 21 undergoes a sandblasting treatment, in which either only the contact face 211 of the clamping block 21 or the overall clamping block 21 undergoes the sandblasting treatment. The sandblasted clamping block 21 generates an improved friction with other object, so that the clamping force of the clamping block 21 is enhanced.

In the embodiment, three clamping blocks 21 and three elastic members 22 are provided. The clamping blocks 21 are disposed with an 120-degree interval in between. The number and interval angle between each two of the clamping blocks 21 effectively improve the clamping stability. The elastic member 22 is a spring.

The driving member 30 comprises a first end 31 and an opposite second end 32. The first end 31 is rotatably disposed in the sleeve ring 10 along the axis L and abuts against the clamping assembly 20. The second end 32 comprises a concave and stepped connection bore 321. The connection bore 321 is divided into a first connection bore 321a and a second connection bore 321b. The diameter of the first connection bore 321a is larger then the diameter of the second connection bore 321b. The connection bore 321 is applied to be combined with a wrench.

Also, the first end 31 of the driving member 30 comprises an abutting block 40 formed in a disc shape. The abutting block 40 abuts against each clamping block 21 of the clamping assembly 20. Therein, the abutting block 40 is allowed to be separately arranged from the driving member 30 or integrally formed with the driving member 30. Referring to FIG. 2 to FIG. 3, in an embodiment of the present invention, the abutting block 40 is separately arranged from the driving member 30. Referring to FIG. 8, in another embodiment of the present invention, the abutting block 40 is integrally formed with the driving member 30.

Further, the driving member 30 comprises a concave engagement groove 33 on an outer periphery in adjacent to the first end 31, and a c-clamp 50 is disposed in the engagement groove 33, as shown by FIG. 3, FIG. 6, and FIG. 8.

A resisting member 60 is combined with the combination portion 12 of the sleeve ring 10, with an operation hole 61 passing through the resisting member 60. The driving member 30 is rotatably combined with the operation hole 61. The outer diameter of the abutting block 40 is larger than the inner diameter of the operation hole 61. Therein, the operation hole 61 is divided into a first hole section 611 and a second hole section 612. The inner diameter of the first hole section 611 is smaller than the inner diameter of the second hole section 612. The first hole section 611 comprises a thread, so that the driving member 30 is screwed to the first hole section 611 of the operation hole 61. In the embodiment, the second hole section 612 faces the receiving groove 11 of the sleeve ring 10, as shown by FIG. 3, FIG. 6, and FIG. 8.

To clamp an object with the clamping assembly 20, the user controls the driving member 30 to rotate with respect to the axis L, and the clamping assembly 20 slides obliquely along the guiding portion 111, so that the contact face 211 of each clamping block 21 is attached to the guiding portion 111, such that the attachment relationship between each clamping block 21 and the guiding portion 111 generates a stable friction force, by which each clamping block 21 stably moves away from or toward the axis L, thereby adjusting the specification matching the size of the to-be-clamped object.

Referring to FIG. 3 to FIG. 4, when each clamping block 21 moves away with respect to the axis L, each clamping block 21 retracts into the receiving groove 11, and each elastic member 22 is in an expanded status, so that the clamping assembly 20 is used to clamp an object with a larger size; Referring to FIG. 6 to FIG. 7, when each clamping block 21 moves toward the axis L, each clamping block 21 is protruding and exposed from the receiving groove 11, and each elastic member 22 is in a compressed status, so that the clamping assembly 20 is used to clamp an object with a smaller size.

With the foregoing configuration, the present invention achieves following advantages.

By use of the driving member 30 to control the axial movement of the clamping assembly 20, the opening and closing of the clamping assembly 20 is adjusted to clamp objects with different sizes, so as to enhance the application scope of the tool.

Also, the movement of the clamping assembly 20 is easily controlled through the rotation of the driving member 30, so as to be efficiently adjusted to the needed specifications for clamping objects with different sizes, thereby increasing the operation efficiency.

The guiding portion 111 of the receiving groove 11 enables each clamping block 21 to slide along a specific track, such that the clamping process is accurately carried out, thereby effectively controlling the clamping force and the clamping position.

Through the elastic members 22 of the clamping assembly 20, the present invention ensures the stable connection between the clamping blocks 21, so that the clamping force is stably provided during the clamping process, preventing accidental slipping.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A gripping tool, comprising:
a sleeve ring defining an axis passing through a center thereof, with a receiving groove and a combination portion disposed on two ends of the sleeve ring with respect to the axis, the receiving groove in communication with the combination portion, the receiving groove comprising a guiding portion;
a clamping assembly disposed in the receiving groove of the sleeve ring, the clamping assembly comprising a plurality of clamping blocks and a plurality of elastic members, the clamping blocks arranged around the axis, each of the elastic members having two ends thereof abutting against two of the neighboring clamping blocks; and
a driving member comprising a first end and an opposite second end, the first end rotatably disposed in the sleeve ring and abutting against the clamping assembly, the second end comprising a concave and stepped connection bore; the connection bore divided into a first connection bore and a second connection bore; when the driving member rotates with respect to the axis, the clamping assembly slides obliquely along the guiding portion, so that the clamping blocks move away from or toward the axis.

2. The gripping tool of claim 1, wherein when each of the clamping blocks moves toward the axis, each clamping block protrudes to be exposed from the receiving groove, and each of the elastic members is in a compressed status; when each of the clamping block moves away with respect to the axis, each of the clamping blocks retracts into the receiving groove, and each of the elastic members is in an expanded status.

3. The gripping tool of claim 1, wherein the guiding portion is formed in a cone shape, and an inner wall of the guiding portion is formed in an arc face; each of the clamping blocks comprises a tilting contact face, and the contact face of each clamping block is attached to the guiding portion.

4. The gripping tool of claim 3, wherein each of the clamping blocks comprises two connection faces, and the contact face is connected between the two connection faces; each of the two connection faces comprises a concave recess, respectively, and each of the elastic members has one end thereof abutting against the recess.

5. The gripping tool of claim 3, wherein a resisting member is combined with the combination portion of the sleeve ring, with an operation hole passing through the resisting member; the driving member is rotatably combined with the operation hole.

6. The gripping tool of claim 5, wherein the first end of the driving member comprises an abutting block formed in a disc shape; an outer diameter of the abutting block is larger than an inner diameter of the operation hole; the abutting block abuts against each of the clamping blocks of the clamping assembly.

7. The gripping tool of claim 6, wherein the operation hole is divided into a first hole section and a second hole section; an inner diameter of the first hole section is smaller than an inner diameter of the second hole section; the first hole section comprises a thread, so that the driving member is screwed to the first hole section of the operation hole.

8. The gripping tool of claim 7, wherein the driving member comprises a concave engagement groove on an outer periphery of the driving member in adjacent to the first end, and a c-clamp is disposed in the engagement groove.

9. The gripping tool of claim 6, wherein the abutting block is integrally formed with the driving member; a surface of each of the clamping blocks is treated with a sandblasting treatment.

10. The gripping tool of claim 6, wherein the abutting block is separately arranged from the driving member; a surface of each of the clamping blocks is treated with a sandblasting treatment.
